(19) United States
(12) Patent Application Publication
(10) Pub. No.: US 2026/0203480 A1
(43) Pub. Date: Jul. 16, 2026

(54) METHOD FOR RECONSTRUCTING WORKING FACE OF COAL MINE BASED ON SEARCH SPACE PRUNING AND MULTI-POPULATION DYNAMIC ADJUSTMENT

(71) Applicant: China University of Mining and Technology, Xuzhou (CN)

(72) Inventors: Changfang GUO, Xuzhou (CN); Yuexi LIU, Xuzhou (CN); Zongpeng LIU, Xuzhou (CN); Lei ZHOU, Xuzhou (CN); Mingcheng ZUO, Xuzhou (CN); Tingjiang TAN, Xuzhou (CN); Minfu LIANG, Xuzhou (CN); Gang WU, Xuzhou (CN)

(73) Assignee: China University of Mining and Technology, Xuzhou, JS (CN)

(21) Appl. No.: 19/559,940

(22) Filed: Mar. 6, 2026

(30) Foreign Application Priority Data
Mar. 7, 2025 (CN) 202510270190.7

(51) Int. Cl. G06F 30/27; G01V 20/00; G06F 111/06

(52) U.S. Cl. CPC G06F 30/27; G01V 20/00; G06F 2111/06

(57) ABSTRACT

The present disclosure discloses a method for reconstructing the working face of coal mine based on search space pruning and multi-population dynamic adjustment, which involves the technical field of working face reconstruction of coal mine under incomplete projection conditions, comprising: based on prior knowledge of the working face reconstruction model structure, an initial grid partitioning of the exploration area is performed. Subsequently, multi-scale grid partitioning is achieved through search space pruning, guided by the sum of ray intercepts within each grid unit; to meet the requirements of population diversity and rapid convergence in the multi-population genetic algorithm, a multi-scale reconstruction objective function is constructed based on the partitioned multi-scale grids, this objective function is then solved using a dynamic multi-population genetic algorithm. Therefore, the above-mentioned method for reconstructing the working face of coal mine based on search space pruning and multi-population dynamic adjustment may dynamically adjust and optimize the number of populations, to ensure that the diversity of populations may be maintained, and the search efficiency may be improved, thereby improving the stability and convergence speed of the working face reconstruction operation.

### TECHNICAL FIELD

The present disclosure relates to the technical field of working face reconstruction of coal mine under incomplete projection conditions, in particular, to a method for reconstructing a working face of coal mine based on search space pruning and multi-population dynamic adjustment.

### BACKGROUND

As a new strategy to ensure national energy security, intelligent mining in coal mines represents the trend of high-quality development in the industry. The precise reconstruction and prediction of working faces serve as the foundation and prerequisite for reducing, minimizing, or even eliminating human presence in mines. Electromagnetic wave computed tomography (CT) technology for working faces, as a non-contact detection method, offers low-cost and high-efficiency exploration and has been widely adopted by coal mining enterprises. However, due to the constraints of confined underground spaces and the elongated distribution of working faces, the scanning angles for exploration and observation in working faces are limited. Consequently, the effective CT projection data collected are often incomplete and highly sparse. Reconstruction techniques under such incomplete projection conditions have remained a research hotspot in the industry.

Currently, during CT reconstruction calculations for working faces of coal mine, the detection and reconstruction area must be discretized into regular rectangular units. The scale of the partitioned grid cells directly affects the efficiency and resolution of inversion operations. Generally, the grid partitioning scale is determined based on the scale of the exploration area and the distribution of emission and receiving points. An appropriate grid partitioning scale can accurately reflect the coal seam occurrence within the working face. However, due to constraints in exploration conditions and underground structural factors, uneven coverage of emission points, reception points, and ray density often occurs, making it difficult to select a grid scale suitable for the entire computational area. In 2001, E. Kisslin et al. proposed the triple-grid method, which employs smaller grid scales for ray tracing and selects the most suitable scale as the velocity structure of the detection medium. They found that using larger scales for inversion calculations is the optimal model parameterization method. In 2003, Hu Wei, in the selection of grid scales for seismic travel-time inversion, performed inversion calculations using multiple grid scales from small to large. By applying predetermined weights, the mean of the results from each grid scale was taken as the outcome. This method partially addressed the issue of uneven ray coverage but significantly increased computational time. In 2005, Ma Detang et al. also proposed a dual-grid seismic tomography method, but for the convenience of calculation, the imaging grid scale is required to be an integer multiple of the ray tracing grid.

Existing research has found that achieving good reconstruction results depends critically on determining the optimal grid scale for both forward and inverse modeling prior to computation and performing calculations based on this scale. However, in practical applications, selecting the optimal scale for forward and inverse modeling is not straightforward, and how to finely match the grid partitioning scale with the reconstruction requirements of different working face observation systems has yet to be effectively improved.

Therefore, it is necessary to develop a multi-scale grid adaptive partitioning strategy. By pruning the reconstruction search space, this approach can address the grid scale partitioning issue, allowing for the full utilization of the ray coverage information from the working face CT exploration observation system.

### SUMMARY

An objective of the present disclosure is to provide a method for reconstructing a working face of coal mine based on search space pruning and multi-population dynamic adjustment, this method enables fine-grained grid partitioning of an exploration area of working face, and obtain an optimal solution in terms of comprehensive reconstruction accuracy, stability and efficiency, thereby realizing an effective reconstruction of coal mine working face under a condition of incomplete computed tomography (CT) projection.

To achieve the above purposes, the present disclosure provides a method for reconstructing a working face of coal mine based on search space pruning and multi-population dynamic adjustment, which includes the following steps:
S1, performing preliminary grid partitioning of an exploration area of working face, then conducting multi-scale grid partitioning via search space pruning based on a sum of ray intercepts within each grid; and
S2, constructing a multi-scale reconstruction objective function based on a partitioned multi-scale grid, employing a dynamic multi-population genetic algorithm for population elimination and dynamic adjustment to obtain a super-population. Subsequently, conducting a refined search on the super-population to iteratively solve the multi-scale reconstruction objective function, thereby obtaining an electromagnetic wave absorption coefficient corresponding to the multi-scale grid.

In some embodiments, step S1, including: First, according to a size of the exploration area of working face, it is initially partitioned into square grids; secondly, each preliminarily partitioned square grid is partitioned into four parts; then, according to a ray intercept in the four-segmented grid, a grid that needs to be segmented again is determined, and iterates in turn until a minimum scale is reached.

In some embodiments, in step S2, the multi-scale reconstruction objective function is expressed as follows:

$$f ( X ) = \sqrt{\frac{1}{A} {\sum }_{i = 1}^{A} {( {H}_{0} - {H}_{i} - ln {r}_{i} - {\sum }_{j = 1}^{B} {d}_{ij} {x}_{j} )}^{2}} ;$$

in this formula, A denotes a total number of rays, B denotes several grids, X=(x₁, x₂, . . . , xⱼ, . . . , x_{B}) denotes an absorption coefficient vector to be inverted for B grids, Hᵢ denotes an electromagnetic wave field strength data collected by i-th ray, rᵢ denotes a length of i-th ray, H₀ denotes an initial field strength value of an emission, and dᵢⱼ denotes an intercept of the i-th ray within j-th grid.

In some embodiments, this solution is solved by a dynamic multi-population genetic algorithm, including:
S21, initializing the population, performing independent selection, crossover, and mutation operations across each population to explore different regions of a solution space, and recording elite individuals from all populations;
S22, introducing optimal individuals from various groups regularly into a target population through migration operators, enabling synergistic evolution among populations;
S23, setting a fixed evaluation period, calculating an average fitness of each sub-population, screening the sub-population according to a fitness ranking, and merging the screened sub-population and its corresponding elite individuals to obtain a super-population; and
S24, performing a refined search on the super-population using smaller crossover and mutation probabilities until a preset maximum number of iterations is reached.

In some embodiments, each population uses different control parameters.

Therefore, the present disclosure employs the method for reconstructing the working face of coal mine based on search space pruning and multi-population dynamic adjustment, and has the following technical effects:

(1) The present disclosure effectively integrates grids not traversed by observed rays and reconstructively prunes the search space, making it adaptable to different working face exploration scales and ray distribution characteristics.

(2) Based on the dynamic multi-population genetic algorithm, an accuracy, stability, and efficiency of reconstruction results are significantly improved by dynamically adjusting the number of populations.

The technical solutions of the present disclosure are further described in detail below with reference to the accompanying drawings and embodiments.

### BRIEF DESCRIPTION OF THE DRAWINGS

FIG. 1 is a numerical model of a working face computed tomography (CT) exploration system in the embodiment of a method for reconstructing a working face of coal mine based on search space pruning and multi-population dynamic adjustment;

FIG. 2 is a flow chart of the method for reconstructing the working face of coal mine based on search space pruning and multi-population dynamic adjustment;

FIG. 3 is a schematic diagram of traditional grid partitioning in the embodiment of the method for reconstructing the working face of coal mine based on search space pruning and multi-population dynamic adjustment;

FIG. 4 is a ray number distribution map at different scales in the traditional grid partitioning in the embodiment of the method for reconstructing the working face of coal mine based on search space pruning and multi-population dynamic adjustment;

FIG. 5 is an analysis diagram of reconstruction operation stability at different scales under the traditional grid partitioning in the embodiment of the method for reconstructing the working face of coal mine based on search space pruning and multi-population dynamic adjustment.

### DETAILED DESCRIPTION OF THE EMBODIMENTS

The present disclosure may be explained in more detail by the following embodiments. The purpose of disclosing the present disclosure is to protect all changes and improvements within the scope of the present disclosure, and the present disclosure is not limited to the following embodiments.

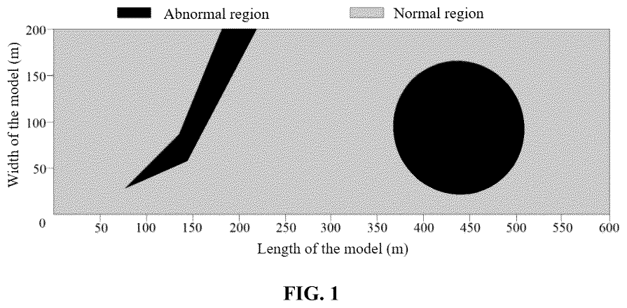

As shown in FIG. 1, the length L of the numerical model of the working face computed tomography (CT) exploration observation system is 200 m, and the width W is 100 m. There are two common geological anomaly areas in the numerical model of the CT exploration observation system in the working face. The electromagnetic wave absorption coefficient of the abnormal area is β₁=1.0 dB/m, and the electromagnetic wave absorption coefficient of the other normal areas is β₂=0.5 dB/m. In the layout of the observation system, the distance between the emission points is 30 m, and the distance between the corresponding receiving points is 10 m. The total number of rays is GS=420.

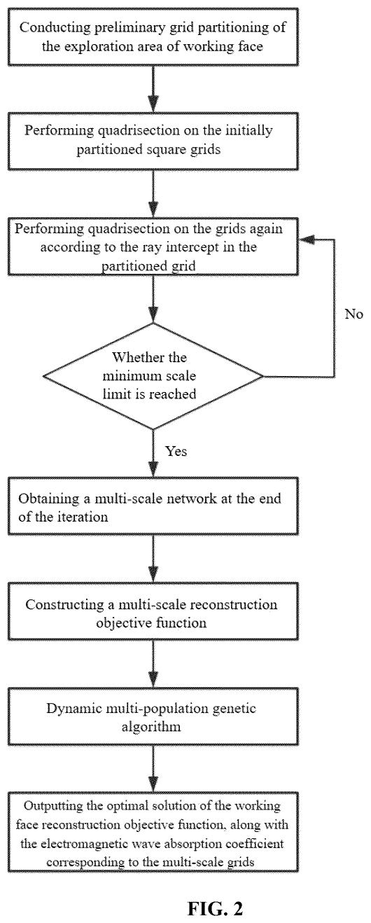

As shown in FIG. 2, the present disclosure provides a method for reconstructing the working face of coal mine based on search space pruning and multi-population dynamic adjustment, including the following steps:

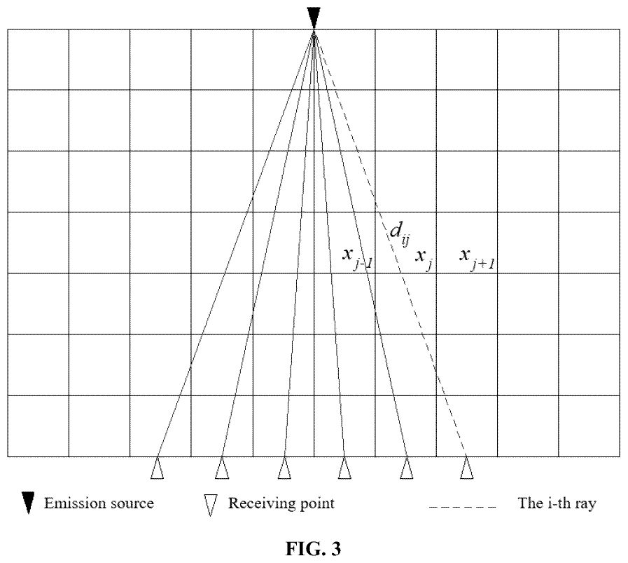

S1, due to the complex environment and electromagnetic wave propagation characteristics of the working face of coal mine, the electromagnetic wave CT projection data are often incomplete, resulting in errors and uncertainties in the CT reconstruction results of the working face. In addition, the grid partitioning of the reconstruction area of the working face is the important step in the reconstruction calculation. The grid partitioning scale directly affects the efficiency and accuracy of the inversion operation. As shown in FIG. 3, before the reconstruction calculation of the working face, the target detection area needs to be discretized into B square grids. Each grid is called a pixel, and xⱼ represents the real absorption coefficient of the j-th grid, j=1, 2, 3, . . . , B.

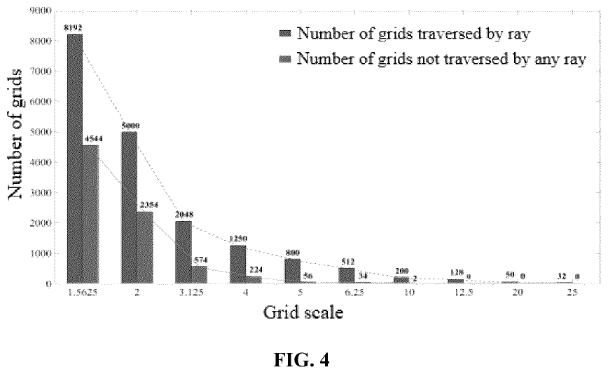

At present, the uniform grid scale partitioning is usually used in the CT reconstruction calculation of the working face, but this method is often used to match the dense ray distribution, and the grid partitioning is dense, which makes the calculation time-consuming. Moreover, there are many network regions without rays passing through, which will increase the stability and speed of solving the problem. If simply increasing the grid spacing and reducing the number of grids, the inversion resolution will be reduced. Specifically, the CT exploration size of the working face is 200 m*100 m. According to the traditional grid uniform scale partitioning method, the grid uniform partitioning scales are set to 25 m, 20 m, 12.5 m, 10 m, 6.25 m, 3.125 m, 2 m, and 1.5625 m, respectively. It is found that as the uniform grid partitioning scale is smaller, the number of grids that are not passed by the observed rays increases almost exponentially, as shown in FIG. 4. These grids that are not penetrated by rays do not carry any effective information of projection data, and also need to participate in the reconstruction operation process, which not only reduces the efficiency of reconstruction, but also increases the difficulty of searching the optimal solution.

To reduce the number of unobserved rays passing through the grid, it is necessary to integrate the invalid grids, that is, the scale of the grid is reduced in the area with dense ray coverage, and the scale of the grid is appropriately increased in the area with ray coverage coefficient, so that each grid has rays passing through and carries effective observation information. In this embodiment, a multi-scale adaptive grid partition method is adopted to effectively prune the target search space through the reconstruction of the working face, to finely match the distribution characteristics of different working face exploration sizes and different density rays, and make full use of the effective information in the incomplete projection data of the CT exploration observation system of the working face. The number of invalid grids is reduced, and the efficiency and accuracy of reconstruction are improved, as follows:

Firstly, according to the CT exploration size of the working face 200 m*100 m, the maximum common divisor is 100 m, the side length of the largest square is ensured, and the number of squares is determined. Finally, the working face is partitioned into two 100 m*100 m squares. The specific operation is as follows: Starting from an angle of the rectangle, the rectangle is partitioned into squares in the interior of the rectangle according to the calculated side length of the square; after each partition, the boundary of the remaining rectangle is updated, and the process is repeated until the entire rectangle is completely partitioned.

Secondly, according to the intercept distribution of the observed rays in the grid, the two squares are subjected to an iterative quadrisection operation, and the sum of the intercepts of all the observed rays in each square grid after quadrisection is calculated. If any of the four quadrisected grids has zero intersections, that is, no observation ray passes through the grid, the grid will not be subjected to subsequent smaller-scale quadrisection processing.

Subsequently, based on the actual exploration size of the working face and taking full account of the efficiency and accuracy requirements of the reconstruction calculation, a minimum scale limit is imposed on the quadrisection process. This limit serves as the iteration stopping criterion, thereby forming the multi-scale grid partitioning result for the working face.

To verify the influence of the minimum resolution of multi-scale partitioning on the reconstruction performance, three minimum partitioning scales of 6.25 m, 3.125 m, and 1.5625 m are set, respectively. As shown in Table 1, the number of grids is effectively reduced by multi-scale partitioning according to the above rules. Especially when the minimum scale is 1.5625 m, the number of grids is reduced from 8192 to 1790 after uniform scale partitioning, which realizes the effective pruning of the reconstruction search space of the working face, which lays a good foundation for the subsequent reconstruction operation.

TABLE 1
Number of grids at different minimum scales

| | |
|---|---|
| Minimum grid scale (m) | Number of grids |

| | | |
|---|---|---|
| 6.25 | Uniform-scale | 512 |
| | Multi-scale | 446 |
| 3.125 | Uniform-scale | 2048 |
| | Multi-scale | 1130 |
| 1.5625 | Uniform-scale | 8192 |
| | Multi-scale | 1790 |

S2, in the calculation of CT reconstruction of the working face, the core problem is to solve an ill-conditioned matrix equation. After the multi-scale partitioning of the reconstruction grid of the working face, the ill-conditioned matrix solving problem is transformed into a functional extremum solving problem, and the multi-scale reconstruction objective function is constructed. Then, the objective function is solved by the dynamic multi-population genetic algorithm with strong global search ability.

The objective function is defined as follows:

$$f ( X ) = \sqrt{\frac{1}{A} {\sum }_{i = 1}^{A} {( {H}_{0} - {H}_{i} - ln {r}_{i} - {\sum }_{j = 1}^{B} {d}_{ij} {x}_{j} )}^{2}} ;$$

in the formula, A denotes the total number of rays, B denotes the several grids, X=(x₁, x₂, . . . , xⱼ, . . . , x_{B}) denotes the absorption coefficient vector to be inverted for B grids, Hᵢ denotes the electromagnetic wave field strength data collected by the i-th ray, rᵢ denotes the length of i-th ray, H₀ denotes the initial field strength value of the emission, and dᵢⱼ denotes the intercept of the i-th ray within the j-th grid.

The geological anomaly tomographic inversion model may be defined as: Find X′ΣC such that f(X′)=min f(X); where X′=(x′₁, x′₂, . . . , x′ⱼ, . . . , x′_{B}) represents the inverted absorption coefficient value for each corresponding grid obtained when the objective function reaches its minimum.

In this embodiment, the dynamic multi-population genetic algorithm (DMPGA) is used to optimize the reconstruction of the working face, including:
S21, population initialization, including the number of population MP=10, the number of individuals in each population NIND=20, the binary digits of variables PRECI=20, the generation gap GGAP=0.95; each population performs selection, crossover and mutation operations independently, and each population has different control parameters, such as crossover probability P_{c}∈[0.75, 0.95], mutation probability Pₘ∈[0.001, 0.05], and the maximum number of iterations MAXGEN=1500. Explore different regions of the solution space and record the elite individuals of all populations.

S22, through the immigration operator, the optimal individuals in various populations are regularly introduced into the target population to achieve information exchange and co-evolution between populations.

S23, population elimination and dynamic adjustment: A fixed evaluation period is set to calculate the average fitness of each subpopulation. Based on the fitness ranking, all individuals from the bottom-ranked subpopulations are directly eliminated. When the number of populations decreases to a predetermined threshold, all remaining subpopulations and the recorded elite individuals are merged to form a super-population with higher diversity and superior genetic combinations.

S24, a refined search is performed on the superpopulation using reduced crossover and mutation probabilities. This strategy further improves the quality and accuracy of the solution while maintaining population stability and accelerating convergence. The process continues until the preset maximum number of iterations is reached. Upon completion, the reconstruction computation concludes, outputting the optimal solution of the working face reconstruction objective function and the electromagnetic wave absorption coefficients corresponding to the multi-scale grids of the working face.

Through the above strategies, the number of populations may be gradually reduced while ensuring population diversity and avoiding premature convergence, finally, a single population containing the optimal individual may be formed. This strategy helps to improve the search efficiency and optimization performance of the genetic algorithm.

To verify the effectiveness of the embodiment method, two groups of comparative experiments are performed. Firstly, based on the multi-population genetic algorithm (MPGA), the influence of uniform scale and multi-scale grid partitioning on the reconstruction operation of the working face is verified; secondly, on the basis of MPGA, the influence of DMPGA on the efficiency and accuracy of working face reconstruction is verified.

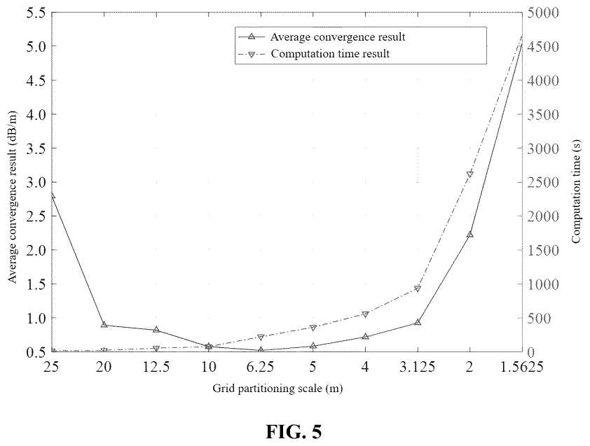

(1) When the uniform scale grid is partitioned, the stability of the reconstruction operation of the working face under different scales is compared (Table 2), and the corresponding relationship between the final average convergence result and the operation efficiency is compared (FIG. 5). It can be seen that when the uniform partitioning scale of the working face is reduced from 25 m to 6.25 m, the convergence result is significantly reduced from 2.7925 dB/m to 0.5210 dB/m after 1500 generations of reconstruction iterative search evolution. When the uniform partitioning scale of the working face continues to decrease from 6.25 m to 1.5625 m, the average convergence result increases from 0.5210 dB/m to 5.0449 dB/m. At the same time, as the grid scale is reduced from 25 m to 1.5625 m, the maximum change range of multiple reconstruction search results increases from 0.0953 dB/m to 5.6625 dB/m, and the average operation time also increases from 17.0324 s to 4642.7151 s. This shows that the stability and efficiency of the reconstruction results are gradually reduced with the reduction of the scale of the reconstruction grid. Therefore, under the condition of incomplete projection of the working face, the reasonable design of the scale of the reconstruction grid has an important influence on the performance of the reconstruction operation.

TABLE 2
Reconstruction results of uniform scale grid partitioning working face

| | | | | | | Average | Maximum |
|---|---|---|---|---|---|---|---|
| Uniform- | First | Second | Third | Fourth | Fifth | value | change |
| scale | iteration | iteration | iteration | iteration | iteration | (m) | (m) |
| 25.0000 | 2.7482 | 2.8109 | 2.7882 | 2.7715 | 2.8435 | 2.7925 | 0.0953 |
| 20.0000 | 0.9172 | 0.8226 | 0.9140 | 0.8442 | 0.9577 | 0.8911 | 0.1351 |
| 12.5000 | 0.8696 | 0.9326 | 0.8715 | 0.5913 | 0.8283 | 0.8186 | 0.3413 |
| 10.0000 | 0.4571 | 0.3635 | 0.4809 | 0.6235 | 0.9562 | 0.5762 | 0.5926 |
| 6.2500 | 0.3618 | 0.3379 | 0.9776 | 0.5250 | 0.4030 | 0.5210 | 0.6397 |
| 5.0000 | 0.6900 | 0.4924 | 0.5301 | 0.2531 | 0.9509 | 0.5833 | 0.6978 |
| 4.0000 | 0.6033 | 0.4774 | 0.6082 | 1.2406 | 0.6618 | 0.7183 | 0.7632 |
| 3.1250 | 0.9514 | 0.7927 | 0.5158 | 1.3227 | 1.0499 | 0.9265 | 0.8070 |
| 2.0000 | 1.8523 | 1.1407 | 1.0610 | 3.9964 | 3.0470 | 2.2195 | 2.9354 |
| 1.5625 | 4.3233 | 1.2772 | 6.9397 | 6.3495 | 6.3349 | 5.0449 | 5.6625 |

In addition, it can be seen from FIG. 4 that when the grid uniform partitioning scale is reduced to 6.25 m, a large number of grids without effective projection information that are not penetrated by the observed rays begin to appear. Based on this, when employing multi-scale grid partitioning, the present embodiment uses 6.25 m, 3.125 m, and 1.5625 m as the minimum grid scales to perform multiple working face reconstruction computations. The corresponding numbers of grid partitions are 446, 1130, and 1790, respectively. The convergence results and reconstruction efficiency obtained are shown in Table 3.

TABLE 3
Multi-scale grid partitioning working face reconstruction operation
results

| Minimum | | | | | | | | Average |
|---|---|---|---|---|---|---|---|---|
| grid | | | | | | | Maximum | Time |
| scale | First | Second | Third | Fourth | Fifth | Average | change | Consumption |
| (m) | iteration | iteration | iteration | iteration | iteration | value (m) | (m) | (s) |
| 6.25 | 0.2041 | 0.2568 | 0.3051 | 0.3550 | 0.6187 | 0.3479 | 0.41463 | 194.0055 |
| 3.125 | 0.6352 | 0.5537 | 0.7213 | 1.2595 | 0.9736 | 0.8286 | 0.7058 | 493.1762 |
| 1.5625 | 0.9476 | 0.8827 | 0.8098 | 1.7779 | 1.2946 | 1.1425 | 0.9681 | 833.2183 |

It can be seen that when the minimum mesh size is 6.25 m, 3.125 m, and 1.5625 m, the average convergence results are reduced from 0.5210 dB/m, 0.9265 dB/m, and 5.0449 dB/m to 0.3479 dB/m, 0.8286 dB/m, and 1.1425 dB/m, respectively. The variation of reconstruction results is reduced from 0.6397 dB/m, 0.8070 dB/m, and 5.6625 dB/m to 0.4146 dB/m, 0.7058 dB/m, and 0.9681 dB/m, respectively. The reconstruction operation time is reduced from 221.4356 s, 936.8193 s, and 4668.2367 s to 194.0055 s, 493.1762 s, and 833.2183 s, respectively. This shows that the accuracy, stability, and efficiency of the reconstruction results are significantly improved by effectively integrating the grids that are not crossed by the observed rays and effectively pruning the reconstruction search space.

(2) Based on MPGA, 100 iterations are set every interval to evaluate all populations, and the reconstruction operation is performed according to the multi-population dynamic adjustment strategy. The results are shown in Table 4.

TABLE 4
Reconstruction results of working face based on DMPGA multi-scale grid
partitioning

| | | | | | | | | Average |
|---|---|---|---|---|---|---|---|---|
| Minimum | | | | | | | Maximum | Time |
| grid scale | First | Second | Third | Fourth | Fifth | Average | change | Consumption |
| (m) | iteration | iteration | iteration | iteration | iteration | value (m) | (m) | (s) |
| 6.25 | 0.3497 | 0.8256 | 0.6177 | 0.8522 | 0.2675 | 0.5825 | 0.5581 | 85.3674 |
| 3.125 | 1.2101 | 0.7299 | 0.8098 | 1.0249 | 1.0312 | 0.9612 | 0.4801 | 219.434 |
| 1.5625 | 0.6079 | 1.1357 | 0.6972 | 1.5972 | 1.4858 | 1.1047 | 0.9893 | 351.7312 |

It can be seen that the average convergence value and change amplitude obtained by the DMPGA multi-scale reconstruction model are not much different from the MPGA algorithm, but the calculation time is reduced from 194.0055 s, 493.1762 s, and 833.2183 s to 85.3674 s, 219.434 s, and 351.7312 s, respectively. The reconstruction efficiency is further improved.

Therefore, the present disclosure adopts the above-mentioned method for reconstructing the working face of coal mine based on search space pruning and multi-population dynamic adjustment. This method is capable of finely matching the exploration dimensions of different working faces and the distribution characteristics of ray paths with varying densities. It enables multi-scale grid partitioning and enhances the accuracy, stability, and efficiency of working face reconstruction.

Finally, it should be noted that the above embodiments are only used to explain the technical solutions of the present disclosure rather than to restrict them. Although the present disclosure is described in detail with reference to the embodiments, those of ordinary skill in the art should understand that they can still modify or equivalently substitute the technical solutions of the present disclosure, and these modifications or equivalent substitutions cannot make the modified technical solutions divorce from the spirit and scope of the technical solutions of the present disclosure.

What is claimed is:

1. A method for reconstructing a working face of coal mine based on search space pruning and multi-population dynamic adjustment, comprising:
S1, performing preliminary grid partitioning of an exploration area of working face, then conducting multi-scale grid partitioning via search space pruning based on a sum of ray intercepts within each grid; and
S2, constructing a multi-scale reconstruction objective function based on a partitioned multi-scale grid, employing a dynamic multi-population genetic algorithm for population elimination and dynamic adjustment to obtain a super-population. Subsequently, conducting a refined search on the super-population to iteratively solve the multi-scale reconstruction objective function, thereby obtaining an electromagnetic wave absorption coefficient corresponding to the multi-scale grid.

2. The method for reconstructing the working face of coal mine based on search space pruning and multi-population dynamic adjustment according to claim 1, wherein in step S1, comprising: first, according to a size of the exploration area of working face, it is initially partitioned into square grids; secondly, each preliminarily partitioned square grid is performed quadrisection; then, according to a ray intercept in the four-segmented grid, a grid that needs to be segmented again is determined, and iterates in turn until a minimum scale is reached.

3. The method for reconstructing the working face of coal mine based on search space pruning and multi-population dynamic adjustment according to claim 1, wherein in step S2, the multi-scale reconstruction objective function is expressed as follows:
$$f ( X ) = \sqrt{\frac{1}{A} {\sum }_{i = 1}^{A} {( {H}_{0} - {H}_{i} - ln {r}_{i} - {\sum }_{j = 1}^{B} {d}_{ij} {x}_{j} )}^{2}} ;$$
in this formula, A denotes a total number of rays, B denotes several grids, X=(x₁, x₂, . . . , xⱼ, . . . , x_{B}) denotes an absorption coefficient vector to be inverted for B grids, Hᵢ denotes an electromagnetic wave field strength data collected by i-th ray, rᵢ denotes a length of i-th ray, H₀ denotes an initial field strength value of an emission, and dᵢⱼ denotes an intercept of the i-th ray within j-th grid.

4. The method for reconstructing the working face of coal mine based on search space pruning and multi-population dynamic adjustment according to claim 1, wherein this solution is solved by a dynamic multi-population genetic algorithm, comprising:
S21, initializing the population, performing independent selection, crossover, and mutation operations across each population to explore different regions of a solution space, and recording elite individuals from all populations;
S22, introducing optimal individuals from various groups regularly into a target population through migration operators, enabling synergistic evolution among populations;
S23, setting a fixed evaluation period, calculating an average fitness of each sub-population, screening the subpopulation according to a fitness ranking, and merging the screened subpopulation and its corresponding elite individuals to obtain a super-population; and
S24, performing a refined search on the super-population using smaller crossover and mutation probabilities until a preset maximum number of iterations is reached.

5. The method for reconstructing the working face of coal mine based on search space pruning and multi-population dynamic adjustment according to claim 4, wherein each population uses different control parameters.
